(19) United States
(12) Patent Application Publication
(10) Pub. No.: US 2026/0249665 A1
(43) Pub. Date: Aug. 27, 2026

(54) Compressor Assembly for a Motor Vehicle

(71) Applicant: MAHLE International GmbH, Stuttgart (DE)

(72) Inventors: Gerrit WÖLK, Stuttgart (DE); Julia REWES, Stuttgart (DE)

(21) Appl. No.: 19/544,272

(22) Filed: Feb. 19, 2026

(30) Foreign Application Priority Data
Feb. 21, 2025 (DE) 102025106756.2

(51) Int. Cl. B60H 1/32

(52) U.S. Cl. CPC B60H 1/3223; B60H 1/32284; B60H 2001/325; B60H 2001/3257

(57) ABSTRACT

A compressor assembly for a motor vehicle is provided. The compressor assembly has a compressor with a compressor housing for conducting and pressurizing a refrigerant, a thermal management module on the compressor housing, with a refrigerant circuit, wherein the compressor is placed in the refrigerant circuit to pressurize the refrigerant, wherein there is at least one retainer on the compressor housing for a functional element in the compressor assembly, preferably formed as an integral part thereof.

### CROSS-REFERENCE TO RELATED APPLICATIONS

This application claims priority from German Patent Application No. 102025106756.2, filed on Feb. 21, 2025, the entirety of which is hereby incorporated by reference herein.

The present invention relates to a compressor assembly for a motor vehicle and a motor vehicle with such a compressor assembly.

Refrigerant lines are often connected to conventional compressors for pressurizing refrigerant circulating in motor vehicle refrigerant circuits, to which additional components such as refrigerant temperature and pressure sensors and valves for filling the compressor or refrigerant circuit with the refrigerant are connected. These refrigerant lines can then be connected to a thermal management module that can contain heat exchangers for heating and cooling the refrigerant and a reservoir for temporarily storing the refrigerant. Because of the large number of components, such a structure is relatively complex and thus expensive to produce.

The object of the invention is to therefore create a better design for a compressor assembly containing the aforementioned compressor and a thermal management module, which is distinguished by a simplified structure and therefore lower production costs.

This is achieved by the subject matter of the independent Numbered Paragraph. Preferred embodiments are the subject matter of the dependent Numbered Paragraphs.

The fundamental concept of the invention is to provide at least one retainer on the compressor housing to which a functional element in the compressor assembly, e.g. a valve or sensor, can be connected.

Connecting the functional element directly to the compressor housing eliminates the need for a more complicated connection thereof to a separate fluid line in the compressor assembly. Consequently, this line is unnecessary, further simplifying the compressor assembly.

Forming the retainer directly on the compressor housing further simplifies it. This is particularly the case when the compressor housing is formed by casting in a pressure casting process. In this case, the retainer can be formed as an integral part of the housing in the casting process, thus eliminating the need for a separate production step.

Consequently, by forming the retainer directly on the compressor housing, a simpler compressor assembly is obtained, resulting in the desired savings in production costs.

The compressor assembly for a motor vehicle obtained with the invention contains a compressor for pressurizing and conducting a refrigerant. The compressor can contain a compressor unit for pressurizing the refrigerant and a housing for the compressor unit. This compressor assembly also contains a thermal management module on the housing connected to the compressor through which refrigerant flows. The thermal management module contains at least one, preferably closed, refrigerant circuit. The compressor is in the refrigerant circuit.

The thermal management module can contain at least two heat exchangers for exchanging heat between the refrigerant and a coolant in a separate coolant circuit. The thermal coupling of the refrigerant circuit and the coolant circuit therefore takes place in the two heat exchangers.

The first heat exchanger can be a condenser, in which the refrigerant is condensed. The heat released thereby can be transferred to the coolant in the heat exchanger. The second heat exchanger can be a chiller in which the refrigerant is vaporized. The heat needed for this is taken from the coolant in the heat exchanger. The two heat exchangers can control the temperature of the coolant.

The coolant circuit can be connected to various vehicle components in the vehicle that require cooling. The thermal management module can have fluid lines for this that are part of the cooling circuit. These fluid lines can be formed in a fluid-conducting element in the thermal management module, with ports to which other functional components in the thermal management module can be connected, e.g. sensors, pumps, or valves, such that the fluid-conducting element can also function as a mount.

The thermal management module can also contain a reservoir for the refrigerant that is incorporated in the refrigerant circuit. The thermal management module can also contain an expansion element, e.g. an expansion valve, which is also in the refrigerant circuit. The compressor therefore forms a pressurizer, the expansion valve an expansion element, and the two heat exchangers form a condenser and an evaporator in the refrigerant circuit.

The compressor housing has at least one retainer for a functional element in the compressor assembly. This retainer can be delimited by the compressor housing, which is preferably made of a metal, ideally aluminum. The retainer is preferably formed as an integral part of the compressor housing.

The retainer preferably comprises a recess in the compressor housing. This retainer is threaded, such that the functional element can be screwed into it. The threading is on the inside of the recess formed in the compressor housing. This results in a simple means of attaching the functional element to the housing, or removing it therefrom if necessary.

There can be at least two retainers on the compressor housing, at a spacing to one another. Consequently, a corresponding number of functional elements can be attached to the compressor housing. The advantages of the invention increase with the number of retainers formed on the compressor housing.

At least one of these functional elements in the compressor assembly is preferably a valve for filling the compressor with refrigerant. Consequently, there is no need for the valve to be attached to a separate refrigerant line connected to the housing, thus substantially simplifying the compressor assembly.

At least one of the functional elements in the compressor assembly is preferably a pressure and/or temperature sensor for the refrigerant. Consequently, there is no need for this sensor to be attached to a separate refrigerant line connected to the housing, thus substantially simplifying the compressor assembly.

At least one of the retainers is preferably a port for a fluid line. This also simplifies the compressor assembly.

Ideally, a check valve is placed in the port.

At least one of the functional elements can have an external threading that is complementary to the internal threading in the recess. This results in a simple and reliable, releasable attachment of the functional element to the compressor housing.

Ideally, the thermal management module is releasably attached directly to the compressor housing.

This releasable attachment is preferably a threaded attachment.

The compressor housing is preferably made of aluminum in a pressure casting process. This is a simple means of producing the compressor housing with the retainers formed thereon.

The thermal management module can also advantageously contain a fluid-conducting module in which there is at least one, preferably two or more, fluid paths for coolant.

This forms a means for connecting various functional components in the compressor and thermal management module to one another.

The invention also relates to a motor vehicle. This motor vehicle contains a coolant circuit and a separate refrigerant circuit. The motor vehicle also contains at least one component that can be cooled by the coolant in the coolant circuit. The interior of the vehicle can also be cooled with this coolant. The vehicle also contains the compressor assembly obtained with the invention. The advantages for the compressor assembly also apply to the motor vehicle obtained with the invention.

Further important features and advantages of the invention can be derived from the dependent claims, drawings, and descriptions of the drawings.

The features specified above and explained below can be used not only in the given combinations, but also in other combinations or in and of themselves, without abandoning the scope of protection for the invention.

Preferred exemplary embodiments of the invention are shown in the drawings and shall be explained in greater detail below, in which the same reference symbols are used for the same, similar, or functionally identical components.

Therein, schematically:

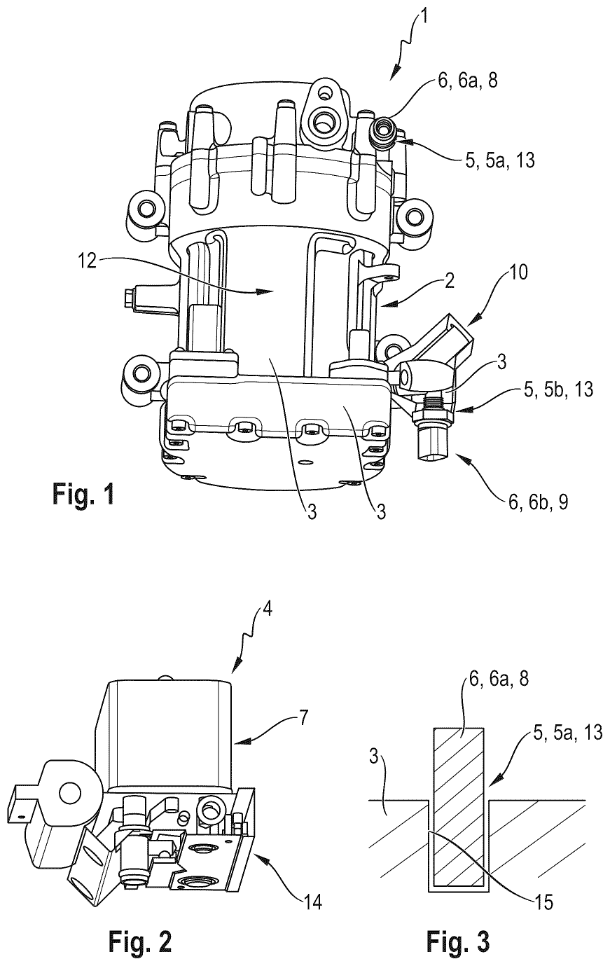

FIG. 1 shows a perspective view of an exemplary compressor in a compressor assembly obtained with the invention,

FIG. 2 shows a perspective view of an exemplary thermal management module in a compressor assembly obtained with the invention,

FIG. 3 shows a sectional view of the compressor housing for the compressor in FIG. 1, showing a retainer for a functional element,

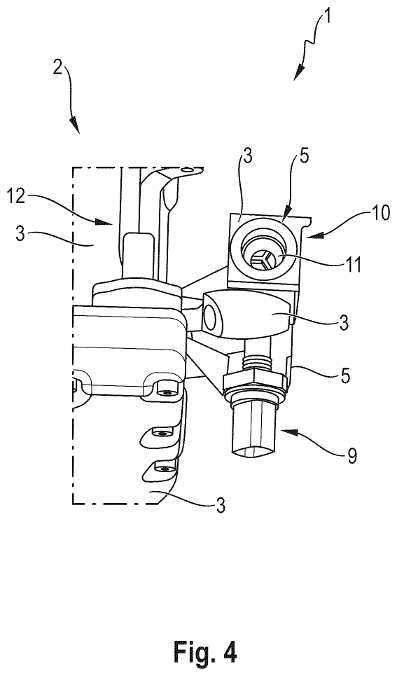

FIG. 4 shows a detail of a variant of the compressor in FIG. 1.

FIGS. 1 and 2 show exemplary illustrations of the compressor assembly 1 obtained with the invention. This compressor assembly 1 contains a compressor 2 for pressurizing and conducting refrigerant. The compressor 2 can contain a compressor unit, not shown in detail, for pressurizing the refrigerant, and a housing 3 with a housing interior 12 containing the compressor unit. The compressor housing 3 is made of aluminum in a casting process in this example.

The compressor assembly 1 also contains a thermal management module 4 attached to the housing 3, through which the refrigerant flows. For purposes of clarity, the thermal management module 4 is not shown in FIG. 1, but instead is shown separately in FIG. 2.

The thermal management module 4 can be releasably attached directly to the compressor housing 3. This attachment can be obtained with one or more threaded fasteners (not shown).

The thermal management module 4 contains a closed refrigerant circuit. The compressor 2 is placed in the refrigerant circuit to pressurize the refrigerant.

The thermal management module 4 can also contain heat exchangers for exchanging heat between the refrigerant and a coolant in a separate coolant circuit. In this case, one of the heat exchangers can be a condenser, and the other can be a chiller.

Only one heat exchanger 7 is shown in FIG. 2, for purposes of clarity.

Two retainers 5 are formed on the compressor housing 3 in FIG. 1. A functional element 6 in the compressor assembly 1, or compressor 2, is placed in each of these retainers 5.

In this example, a first functional element 6, 6a in the form of a valve 8 for filling the compressor 2 with refrigerant is placed in the first retainer 5a.

FIG. 3 shows a sectional view of the first retainer 5a in the compressor housing 3. This retainer 5 can be formed by a recess 13 in the compressor housing, thus forming an integral part of the housing 3. The functional element 6 can therefore be placed in the recess 13.

The recess 13 can have an internal threading (not shown), into which the first functional element 6a, or valve 8, can be screwed. The functional element 6 can have an outer threading for this (not shown), which is complementary to the internal threading in the recess 13.

The second functional element 6b in this example is a sensor 9, placed in the second retainer 5b, for determining the pressure and temperature of the refrigerant. The second retainer 5b can be identical to the first retainer 5a, such that the above explanations for the first retainer 5a apply mutatis mutandis to the second retainer 6b and the second functional element 6b.

The sensor 9 can be at the intake end of the compressor 2, or its compressor unit, in the refrigerant circuit. The sensor could also be placed at the pressurizing end.

There can also be two sensors 9 in separate retainers 5, one of which is placed at the pressurizing end of the compressor unit in the refrigerant circuit, and the other is placed at the intake end. For this, the two retainers 5 are placed appropriately on the compressor housing 3.

FIG. 4 shows an illustration of another variant of the compressor assembly 1, containing the compressor 2 with the compressor housing 3, where the sensor 9 is located.

As FIG. 4 shows, the retainer 5 on the compressor housing 3 can also form a port 10 for a fluid line (not shown) in the refrigerant circuit.

There can also be a check valve 11 in this retainer 5 or port 10, which is connected to the fluid line 10.

The specification can be readily understood with reference to the following Numbered Paragraphs:
Numbered Paragraph 1. A compressor assembly (1) for a motor vehicle, which has
   a compressor (2) with a compressor housing (3) for conducting and pressurizing a refrigerant,
   a thermal management module (4) on the compressor housing (3), with a refrigerant circuit, wherein the compressor (2) is placed in the refrigerant circuit to pressurize the refrigerant,
wherein there is at least one retainer (5) on the compressor housing (3) for a functional element (6) in the compressor assembly (1), preferably formed as an integral part thereof.
Numbered Paragraph 2. The compressor assembly according to Numbered Paragraph 1, characterized in that the retainer (5) is a recess (13) in the compressor housing (3), preferably with an internal threading into which the functional element (6) can be screwed.
Numbered Paragraph 3. The compressor assembly according to Numbered Paragraph 1 or 2, characterized in that there are at least two retainers (5a, 5b, 5) on the compressor housing (3), spaced apart from one another.
Numbered Paragraph 4. The compressor assembly according to any of the Numbered Paragraphs 1 to 3, characterized in that at least one of the functional elements (6) is a valve (8) placed in one of the retainers (5, 5a) for filling the compressor (1) with refrigerant.
Numbered Paragraph 5. The compressor assembly according to any of the preceding Numbered Paragraphs, characterized in that at least one of the functional elements (6) is a sensor (9) placed in one of the retainers (5, 5b) for determining the pressure and/or temperature of the refrigerant.
Numbered Paragraph 6. The compressor assembly according to any of the preceding Numbered Paragraphs, characterized in that at least one of the retainers (5) is or contains a port (10) for an (external) fluid line.
Numbered Paragraph 7. The compressor assembly according to Numbered Paragraph 6, characterized in that there is a check valve (11) in the port (10).
Numbered Paragraph 8. The compressor assembly according to any of the Numbered Paragraphs 2 to 7, characterized in that at least one of the functional elements (6a, 6b, 6) has an external threading that is complementary to the internal threading in the recess (13).
Numbered Paragraph 9. The compressor assembly according to any of the preceding Numbered Paragraphs, characterized in that the thermal management module (4) is releasably attached directly to the compressor housing (3).
Numbered Paragraph 10. The compressor assembly according to Numbered Paragraph 9, characterized in that the releasable connection is a threaded connection.
Numbered Paragraph 11. The compressor assembly according to any of the preceding Numbered Paragraphs, characterized in that the compressor housing (3) is made of aluminum in a pressure casting process.
Numbered Paragraph 12. A motor vehicle that has
   a compressor assembly (1) according to any of the preceding Numbered Paragraphs,
   a coolant circuit that is separate from the refrigerant circuit (2) in the thermal management module (4), wherein the coolant circuit and refrigerant circuit (2) are thermally coupled to one another in the two heat exchangers (7),
   at least one vehicle component that can be cooled by the coolant circulating in the coolant circuit.
Numbered Paragraph 13. The motor vehicle according to Numbered Paragraph 12, characterized in that the motor vehicle has an interior that can be cooled by the coolant circulating in the coolant circuit.

List of Reference Symbols

| | |
|---|---|
| 1 | compressor assembly |
| 2 | compressor |
| 3 | compressor housing |
| 4 | thermal management module |
| 5 | retainer |
| 5a, 5b | first and second retainers |
| 6 | functional element |
| 6a, 6b | first and second functional elements |
| 7 | heat exchanger |
| 8 | filling valve |
| 9 | sensor |
| 10 | port |
| 11 | check valve |
| 12 | housing interior |
| 13 | recess |
| 14 | fluid-conducting element |
| 15 | housing wall |

1-13. (canceled)

14. A compressor assembly for a motor vehicle, comprising a compressor with a compressor housing, the compressor for conducting and pressurizing a refrigerant, the compressor establishes a portion of a refrigerant circuit, the refrigerant circuit disposed within a thermal management module, the thermal management module is disposed upon the compressor housing, further comprising at least one retainer on the compressor housing for a functional element in the compressor assembly, the retainer is formed as an integral part of the compressor housing.

15. The compressor assembly according to claim 14, wherein the retainer is a recess in the compressor housing, wherein the recesses comprises an internal threading into which the functional element can be screwed.

16. The compressor assembly according to claim 14, wherein the retainer comprises at least first and second retainers disposed upon the compressor housing, the first and second retainers being spaced apart from one another.

17. The compressor assembly according to claim 16, wherein the functional element is a plurality of functional elements, wherein at least one of the functional elements is a valve placed in one of the first or second retainers for filling the compressor with refrigerant.

18. The compressor assembly according to claim 17, wherein at least one of the plurality of functional elements is a sensor disposed in one of the first or second retainers, the sensor being configured for determining the pressure and/or temperature of the refrigerant.

19. The compressor assembly according to claim 16, wherein at least one of the first or second retainers is or contains a port for a fluid line.

20. The compressor assembly according to claim 19, further comprising a check valve in the port.

21. The compressor assembly according to claim 17, wherein at least one of the plurality of functional elements comprises an external threading that is complementary to the internal threading in the recess.

22. The compressor assembly according to claim 14, wherein the thermal management module is releasably attached directly to the compressor housing.

23. The compressor assembly according to claim 22, wherein the releasable connection is a threaded connection.

24. The compressor assembly according to claim 14, wherein the compressor housing is made of aluminum in a pressure casting process.

25. A motor vehicle comprising a compressor assembly according to claim 14, a coolant circuit that is separate from the refrigerant circuit in the thermal management module, wherein the coolant circuit and refrigerant circuit are thermally coupled to one another in two heat exchangers, and at least one vehicle component that is configured to be cooled by the coolant circulating in the coolant circuit.

26. The motor vehicle according to claim 25, wherein the motor vehicle comprises an interior that is configured to be cooled by the coolant circulating in the coolant circuit.

27. The compressor assembly according to claim 19, wherein the port contained by at least one of the first or second retainers is a port for an external fluid line.
